(19) United States
(12) Patent Application Publication
(10) Pub. No.: US 2005/0023071 A1
(43) Pub. Date: Feb. 3, 2005

(54) Joystick-operated driving system

(76) Inventor: Bruce Ahnafield, Indianapolis, IN (US)

Correspondence Address: MAGINOT, MOORE & BECK;BANK ONE CENTER/TOWER, 1111 MONUMENT CIRCLE, INDIANAPOLIS, IN, 46204, US

(21) Appl. No.: 10/632,543

(22) Filed: Aug. 1, 2003

(51) Int. Cl. B60K 26/00

(52) U.S. Cl. 180/333; 74/471 R; 74/481

(57) ABSTRACT

A system for use by a physically impaired driver for controlling a vehicle includes an actuator assembly operably coupled to the pedals. The actuator assembly includes a pair of electrical motors operable through a rack and linkage arrangement to depress the brake pedal, and a third electric motor operable through a rack and linkage arrangement to depress the accelerator pedal. The actuator assembly is pivotably mounted above the pedals to pivot when the brake pedal is depressed. A joystick controller is mounted to the vehicle and includes a platform with a grip and arm supports. The joystick controller is operable in a fore-aft direction to control braking and acceleration, and can be tilted side-to-side to operate the vehicle turn signals. The joystick controller includes features for keeping the controller clear of dust and debris and for channeling wiring associated with the turn signals.

### BACKGROUND OF THE INVENTION

The present invention relates to a system for controlling a motor vehicle, and particularly for operating the vehicle accelerator and brakes. This invention can be readily applied to vehicle control systems for physically impaired drivers.

A conventional motor vehicle, such as an automobile, is designed for a driver having full and substantially unrestricted use of all of their limbs. The standard vehicle controls include a rotary operating steering wheel, a depressible brake pedal, and a depressible accelerator pedal. Of course, it is known that the steering wheel is operated manually, while the brake and accelerator pedals are operated by the driver's feet. Current production vehicles assume that the driver has full use of his/her hands and feet in order to operate these vehicle controls.

Unfortunately, a significant percentage of the driving population does not have full use of all of their limbs. For instance, drivers with certain physical disabilities may be unable to use their legs to operate the brake and accelerator pedals. Although no production vehicles have been developed to account for physically-impaired drivers, a significant amount of effort has been expended in developing systems that can be integrated into an existing vehicle control system to accommodate this driving population. One such system is depicted and described in U.S. Pat. No. 4,722,416, which issued on Feb. 2, 1998 to one of the inventors of the present invention. A system embodying the teachings of the '416 patent has been sold by Ahnafield Corporation as its “Joystick Driving Control®” system. The basic components of this system are shown in FIG. 1. In particular, a vehicle V, which includes a steering wheel S, a brake pedal B, and an accelerator pedal A, is provided with a braking/acceleration control system 10 that integrates with the vehicle controls. A joystick controller 12 is provided that can be manually manipulated by the physically-impaired driver. This joystick controller is linked to a control box 14 which carries an electronic circuit or microprocessor that produces control signals in response to movement of the joystick controller 12. These signals operate a brake control cylinder 16 or an accelerator control cylinder 18. These cylinders are part of a hydraulic system that can be actuated by signals from the control box 14 to depress or retract either of the two control pedals B, A. In certain applications, the joystick controller 12 can be a two-axis joystick, meaning that movement in one direction, say left or right, can be used to operate the vehicle steering in lieu of the steering wheel S, while movement in a perpendicular direction, such as forward and backwards, controls either the brake or accelerator pedal.

While the Joystick Driving Control® vehicle control system has been very successful in improving the freedom and mobility of the physically-impaired driver, there is always room for improvement. One problem faced by this and other vehicle control systems is that they require significant modification of the existing vehicle and are very difficult and time-consuming to install. Another difficulty faced by some driving control systems is the “fail-safe” mode of operation of the system. For instance, in some prior vehicle control systems, a failure of certain components of the system can compromise the ability of the driver to achieve a safe, controlled stop of the vehicle. The Joystick Driving Controls®system of the Ahnafield Corporation has implemented a fail-safe condition in which all actuators return to a neutral position so that there can be no inadvertent application of the accelerator. In addition, this system provides redundancy for the brake actuators so that the failure of one actuator does not leave the brake pedals inoperable. While the Joystick Driving Control® system has an impeccable safety record, there again is always room for improvement to insure the continued safety of the physically-impaired driver. Thus, there remains a need for improvements to vehicle control systems, particularly those intended for use by the physically-impaired driver.

### SUMMARY OF THE INVENTION

To address this continuing need, the present invention provides a system for use by a physically impaired driver for controlling the brake pedal and accelerator pedal of a vehicle. In one embodiment, the system includes a manually manipulated hand controller, movable in a first direction to control the brake pedal and in a second direction to control the accelerator pedal. An actuator assembly includes a first actuator operably coupled to the brake pedal to depress the brake pedal when activated, and a second actuator operably coupled to the accelerator pedal to depress the accelerator pedal when activated. An electrical control system connects the hand controller to the actuator assembly and is operable to activate the first actuator when the hand controller is moved in the first direction and to activate the second actuator when the hand controller is moved in the second direction. In one feature of this embodiment, a housing is provided for supporting the actuator assembly, in which the housing is pivotably mounted to the vehicle above the brake pedal so that the actuator assembly pivots relative to the vehicle when the first actuator is activated to depress the brake pedal. The accelerator actuator is provided with a U-joint linkage to accommodate this pivoting movement of the actuator assembly.

The housing can include a mounting clamp configured to engage the steering column of the vehicle. This clamp can be affixed with only minimal modification to the vehicle dashboard. The housing also includes a hinge connecting the housing to the mounting clamp to accommodate the pivoting movement of the housing and actuator assembly when the first actuator operates on the vehicle brake pedal. In one feature of the invention, a support arm is provided for connecting the hand controller to the housing. The support arm holds the hand controller in a position that does not interfere with the wheelchair of a driver while orienting the hand controller for easy access by the driver. In one embodiment, a support arm extends from the mounting clamp for supporting the hand controller. Preferably, the housing includes exterior padding for the comfort of the driver.

In another feature of the invention, the actuator assembly includes a brake actuator system operably coupled to the brake pedal to depress the brake pedal when activated. The brake actuator system includes a primary electric motor and a secondary electric motor, operable independent of the primary electric motor. The secondary motor is preferably operable in the event of an emergency or the occurrence of a failure of the primary motor. A linkage assembly is provided for commonly coupling the primary and secondary electric motors to the brake pedal. In a preferred embodiment, each of the primary and secondary motors includes a rack and pinion arrangement for translating motor rotary motion to linear motion. A link extends from each rack to a common bracket engaged to the vehicle brake pedal or pedal arm.

In accordance with a further aspect of the invention, at least the primary brake motor is a reversible motor. The actuator assembly includes motor control circuitry that is operable in response to signals from the hand controller to activate the primary brake motor in a forward direction to depress the vehicle brake pedal. The motor control circuitry is also operable to direct the primary brake motor to operate in a reverse direction to release the brake pedal. The secondary brake motor can be similar controlled. In some embodiments, the secondary brake motor is operable in emergency braking conditions. In these embodiments, the secondary motor is capable of more rapid actuation of the brake pedal than the primary brake motor. In contrast, the primary brake motor is configured for more accurate actuation to permit partial activation of the brake, as may occur during normal driving conditions.

The actuator assembly also includes an accelerator actuator system that is operably coupled to the accelerator pedal to depress the accelerator pedal when activated. The electrical control system is also operable to activate the accelerator actuator when the hand controller is moved in the second direction. The accelerator actuator includes an electric motor that is connected to a rack gear through a free-wheeling clutch. When the clutch is energized, the accelerator motor extends the rack gear and associated linkage to depress the accelerator pedal. When the accelerator is to be deactivated, the clutch is deactivated—i.e., is permitted to freewheel—so that the return spring of the accelerator pedal itself pushes the accelerator linkage back to its neutral position.

In an embodiment of the invention, the actuator assembly includes a support plate that commonly supports the accelerator motor as well as the primary and secondary braking motors. The support plate is pivotably mounted to the vehicle above the brake pedal so that the support plate pivots relative to the vehicle when the brake actuator system is activated to depress the brake pedal.

In another aspect of the invention, the manually manipulated hand controller includes a joystick assembly mounted to the slide member wherein the joystick assembly includes a platform, a gripping post at a forward end of the platform and a pair of offset support posts at a rearward end of the platform. The gripping post is arranged to be grasped by the driver to move the joystick in the fore and aft direction when the driver's e forearm is resting on the platform. The pair of offset support posts flank the opposite sides of the forearm and provide a reaction surface for tilting the platform to activate the turn signal switches. The support post also held support and retain the driver's arm during operation of the joystick assembly to reduce the risk of inadvertent disengagement of the driver's hand from the joystick assembly.

The gripping platform is mounted to permit side-to-side tilting concurrently with fore and aft movement of the joystick assembly and slide member. The gripping platform includes means for preventing tilting of the platform in the fore-aft direction. In one embodiment, this means is in the form of fore and aft walls that engage a slide block on which the joystick is mounted. The walls are configured to permit side-to-side tilting.

A further feature of the inventive system contemplates that the slide member defines at least one wiring channel for receiving a plurality of electrical wires therethrough. The wires can be associated with the turn signal switches activated by tilting the joystick assembly. The wiring channels direct the wires from the switches through the slide member so that the plurality of wires can pass through the slide channel in the body of the hand controller without interfering with the sliding movement of the slide member within the slide channel.

In another embodiment of the invention, the manually manipulated hand controller includes a body defining a channel and an upward facing slot in communication with the channel. The slide member is disposed within the channel for sliding movement in a fore-aft direction. Means responsive to the position of the slide member within the channel can be provided for generating control signals indicative of the desired vehicle command—i.e., acceleration or braking. The joystick assembly mounted to the slide member through the channel and is manually manipulable to slide the slide member in the fore-aft direction within the channel. Preferably, a slide block connects the joystick assembly to the slide member, with the slide block traversing the upward facing slot.

In a feature of this embodiment, the slide block has a length that is less than the length of the slide member in the fore-aft direction. A top plate is disposed over the upward facing slot, with the top plate defining a housing slot in communication with the upward facing slot and a recess surrounding the housing slot. A larger slot cover is disposed within the recess and has a length that is less than a length of the recess. The larger slot cover also defines a first slot in communication with the housing slot, wherein the first slot has a length greater than the length of the slide block but less than the length of the housing slot. The assembly is completed by a smaller slot cover also disposed within the recess between the larger slot cover and the slide block. The smaller slot cover has a length less than the length of the larger slot cover but greater than the length of the first slot. The smaller slot cover further defines a second slot having a length slightly greater than the length of the slide block and greater than the length of the first slot, but less than the length of the larger slot cover. This combination of recess and slot covers provides a closure for the housing slot so that the slide member can slide within the body with minimal risk of introduction of dust and other contaminants into the slide channel that might foul the movement of the slide member or disturb the associated electrical components.

It is one object of the invention to provide a system that can be easily managed by a person having a physical disability that might otherwise prevent that person from operating a motor vehicle. One important object is to provide such a system that can provide that driver with the greatest ability to control the vehicle braking and acceleration.

A further object of the invention resides in features that make the system easy to retrofit to an existing vehicle, specifically with as little disruption to the driver-side area of the vehicle. Yet another object is accomplished by features that ensure stable and reliable actuation of the brake pedal, especially in an emergency braking condition.

These and other objects, as well as many benefits of the present invention, will become apparent upon consideration of the following written description, taken together with the accompanying figures.

### DESCRIPTION OF THE FIGURES

FIG. 1 is a perspective view of one type of prior art vehicle control system.

FIG. 2 is front perspective view of a vehicle dashboard and vehicle control systems with the joystick control system in accordance with one embodiment of the present invention.

FIG. 3 is a perspective view of the joystick controller component of the joystick control system shown in FIG. 2.

FIG. 4 is a top view of the control block of the joystick controller shown in FIG. 3.

FIG. 5 is an end partial cross-sectional view of the control box shown in FIG. 4, taken along line 5-5 as viewed in the direction of the arrows.

FIG. 6 is an enlarged perspective view of a spring stop used with the control box shown in FIGS. 4 and 5.

FIG. 7 is an end partial assembly view of components of the joystick controller shown in FIG. 3.

FIG. 8 is top elevational view of a slide block incorporated into the partial assembly shown in FIG. 7.

FIG. 9 is a side view of a further partial assembly of components of the joystick control system shown in FIG. 3.

FIG. 10 is an end view of the rocker and hand-held components of the joystick control system shown in FIG. 3.

FIG. 11 is an exploded view of a top portion of the control box of the joystick control system shown in FIG. 3.

FIG. 12 is a top view of an actuator control apparatus used with the vehicle control system shown in FIG. 2.

FIG. 13 is an enlarged perspective view of the integration of the primary and secondary brake actuators to the brake pedal in accordance with the embodiment shown in FIG. 2.

FIG. 14 is an enlarged perspective view of the integration of the accelerator actuator integrated with the accelerator pedal in accordance with the control system embodiment shown in FIG. 2.

FIG. 15 is an enlarged perspective view of the mounting system for supporting the components of the vehicle controls system shown in FIG. 2.

FIG. 16 is a bottom perspective view of a controller housing, rack gear, sensor and limit switches in accordance with one embodiment of the joystick controller of the present invention.

FIG. 17 is a top view of the rack gear and a limit switch depicted in FIG. 16.

FIG. 18 is a partial cross-section view of the interface between the rack gear and drive link shown in FIG. 12.

FIG. 19 is a representation of the mounting plate for the assembly shown in FIG. 12 with an alternative hinge arrangement in accordance with another embodiment of the invention.

### DESCRIPTION OF THE PREFFERED EMBODIMENTS

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

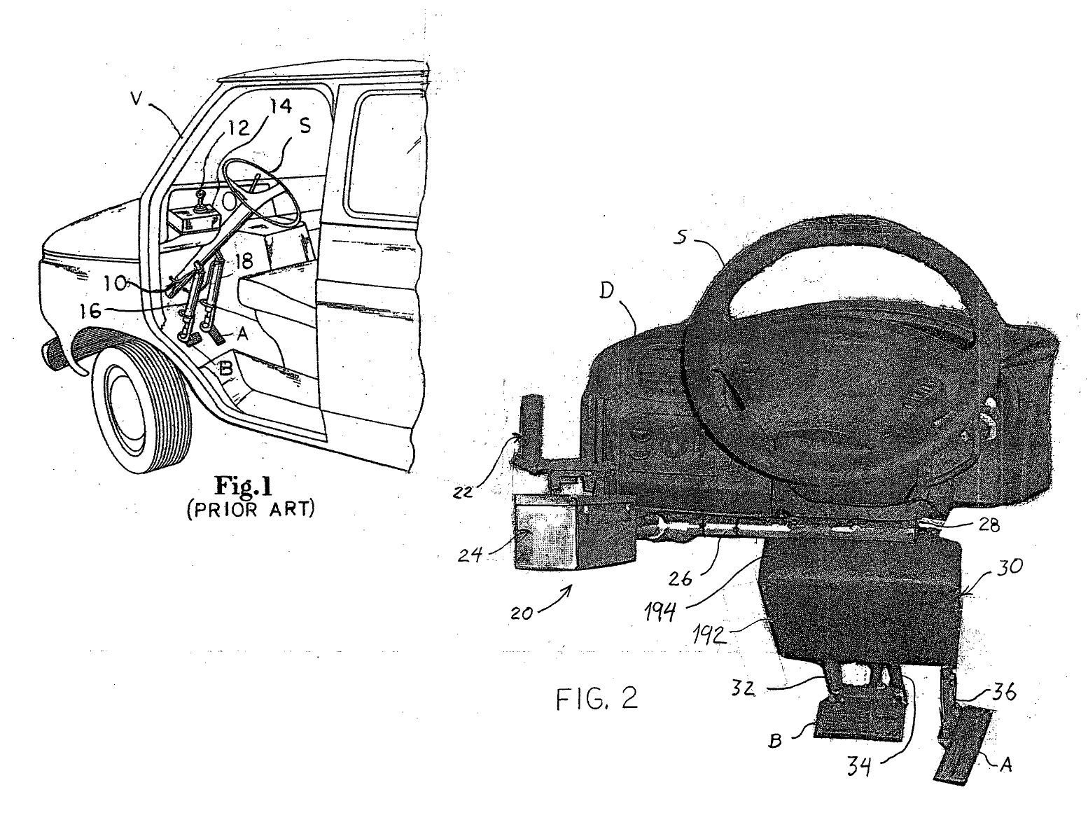

The present invention contemplates a vehicles control system for integration into an existing vehicle. In particular, the vehicle control system 20 of the present invention interfaces with the vehicle brake pedal B and accelerator pedal A, as shown in FIG. 2. Moreover, the control system 20 is supported relative to the column for the steering wheel S, and requires only minimal modification to the vehicle dashboard D. As is typical in the industry, the vehicle is preferably a van-type vehicle, such as the van V depicted in FIG. 1, since vehicles of this type more readily accommodate wheelchair-bound drivers. However, it is understood that the principles of the present invention can be implemented on vehicles of virtually any type, including sedans, with appropriate modification and adjustment of the relative dimensions of the system 20.

In the illustrated embodiment, the control system 20 is configured for controlling only the brake and accelerator pedals—i.e., the system does not provide an interface to control the steering of the vehicle. However, it is understood that the principles of the present invention can be integrated into a system that permits vehicle steering control other than through the steering wheel S itself. For instance, as disclosed in the aforementioned '416 patent, steering control can be implemented by providing 2-axis movement of the joystick controller. However, for the purposes of the present invention, the control system 20 is disclosed as operating only the brake and accelerator pedals.

As shown in FIG. 2, the control system 20 includes a joystick controller supported by a control box 24. In one aspect of the invention the control box 24 is supported by an arm 26 that is mounted to the steering column by way of a steering column mount 28. The steering column mount also supports an actuator mechanism 30 from which extends actuators for controlling the movement of the brake pedal B and the accelerator pedal A. In the preferred embodiment, the actuator mechanism 30 includes a primary brake actuator 32 and a secondary brake actuator 34 that integrates with the brake pedal. In addition, the actuator mechanism 30 includes an accelerator actuator 36 that connects to the vehicle accelerator pedal.

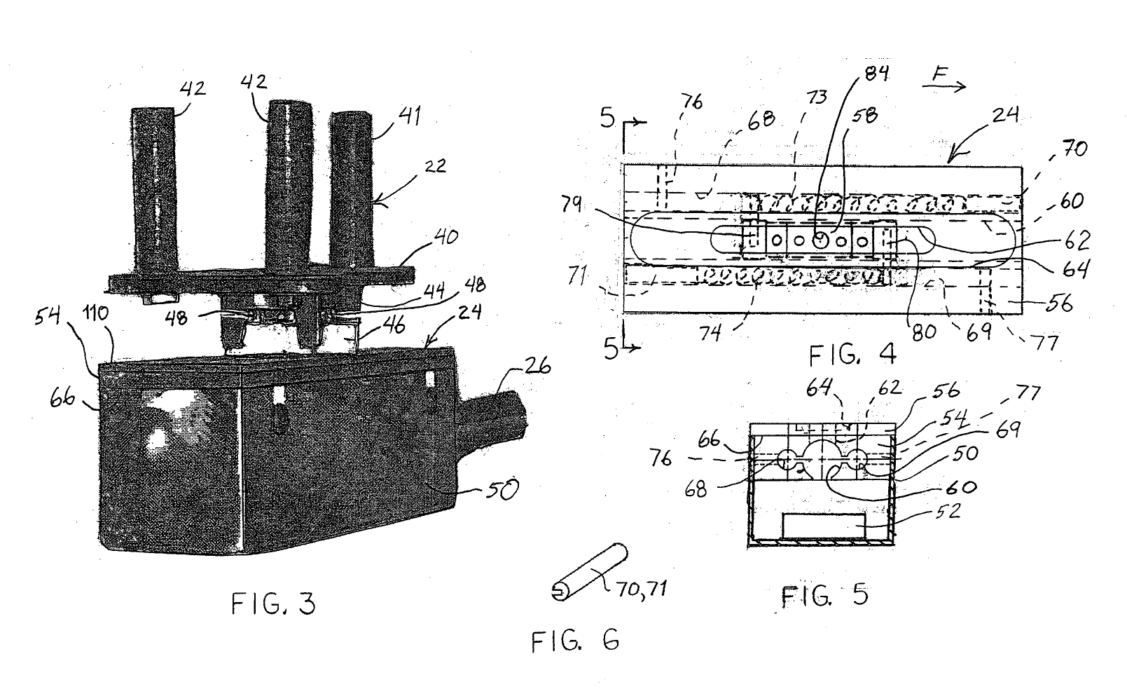

Details of the joystick 22 and control box 24 can be discerned from FIGS. 3-10. As shown in FIG. 3, the joystick controller 22 includes a grip platform 40 from which projects a number of posts. In a preferred configuration, the platform 40 supports a gripping post 41 and offset support posts 42. This configuration is usable by most physically-impaired drivers by simply gripping the post 41 with the forearm positioned between the offset support posts 42. This particular configuration has been found to be very comfortable to the driver and amenable to the precise, controlled movements necessary to manipulate the joystick controller 22. It should be understood that other hand interfaces may be implemented in lieu of the posts 41, 42. For instance, a dual or single post arrangement can be used, as well as a ball grip or a palm grip, all as known in the art.

The grip platform 40 is mounted to a rocker 44 that only permits side-to-side rocking movement. This rocking movement allows the driver to depress turn signal switches 48 mounted to opposite sides of a slide block 46. Thus, by rocking or wobbling the platform 40 to the left or to the right the driver can operate the vehicle turn signals.

The slide block 46 is mounted for linear sliding movement relative to the control box 24. Thus, the physically-impaired driver can move the grip platform 40 forward or backward to operate either the accelerator or the brake, respectively.

The control box 24 includes a cover that houses the internal components of the control box. For instance, controller circuitry 52 can be mounted within the cover 50, where the circuitry translates movement of the joystick controller 22 to specific control signals fed to the actuator mechanism 30 as described herein. The control box 24 further includes a controller housing 54 to which the cover 50 is mounted. Preferably, the controller housing 54 is in the form of a substantially rectangular block as can be discerned from FIGS. 4 and 5. The cover 50 is preferably formed from a stamped sheet of material where the side and end walls are initially provided flat, and then folded upward and welded together to form a box about the controller housing 54. The housing preferably includes a top plate 56 that defines a flange 66 against which the cover 50 abuts to form a sealed enclosure within the cover 50 and controller housing 54.

In one feature of the invention, the controller housing 54 supports a controller slide member 58 that is disposed within a slide channel 60. Preferably, the controller slide member 58 is generally cylindrical in configuration and has a diameter that is slightly less than a cylindrical diameter of the slide channel 60 (see FIG. 5). As shown in FIGS. 7 and 9, the controller slide member 58 is connected to the slide block 46 so that linear movement of the slide block 46 by way of manual pressure on the grip platform 40 will cause the controller slide member 58 to move forward or backward within the control housing 54. A housing slot 62 and recess 64 are provided in the top plate 56 so that the controller slide member 58 can be connected to the slide block 46 (see FIG. 5).

In accordance with a further aspect of the invention, the controller slide member 58 is provided with a tactile feedback and centering feature. In the preferred embodiment, this feature is provided by opposing springs that center the controller slide member 58 within the slide channel 60 when no pressure is applied to the grip platform 40. In addition, the opposing springs provide tactile feedback or resistance as the controller grip platform 40, and therefore the controller slide member 58, is moved further in the forward or backward directions.

Thus, in accordance with the illustrated embodiment, the controller housing 54 is provided with a pair of opposite spring channels 68, 69 that flank opposite sides of the slide channel 60, as best seen in FIG. 5. The channels preferably extend through the entire length of the controller housing 54 to facilitate assembly of the components of the control box. Corresponding spring stops 70, 71 can be disposed within opposite ends of the spring channels 68, 69, as depicted in FIG. 4. The spring stops can be friction-fit pins such as the pins 70, 71 shown in FIG. 6. In this instance, the pins are pressed into the appropriate ends of the spring channels 68, 69 to contain corresponding springs 73, 74 within the spring channels. Once the springs 73, 74 have been loaded into the corresponding spring channels 68, 69, travel stops 76, 77 can be inserted into the controller housing 54 to block the open ends of the two channels. In a preferred embodiment, the travel stops 76 can be in the form of screws threaded into bores defined in the controller housing 54 that intersect the open ends of the spring channels 68, 69.

As can be appreciated from FIG. 4, the two springs 73, 74 are arranged to act in opposite directions. The controller slide member 58 is provided with spring engagement pins 79, 80 at its corresponding opposite ends. In the illustrated embodiment, the pins 79, 80 are press-fit into corresponding bores formed in the opposite ends of the slide member 58. These engagement pins 79, 80 are arranged to contact the free end of the springs 73, 74 as shown in FIG. 4. Thus, it can be appreciated that each spring 73, 74 is trapped or contained between a corresponding spring stop 70, 71 and an engagement pin 79, 80. With this arrangement, it should be understood that movement of the controller slide member 58 in one direction, for instance the forward direction, will compress one spring, such as spring 73, while permitting the opposite spring, such as spring 74, to extend. Likewise, movement of the controller slide member 58 in the opposite, or backwards, direction will compress the spring 74 and extend the spring 73.

Preferably, the two springs are configured so that they maintain some pressure against the engagement pins 79, 80, even when the pins reach their corresponding travel stops 76, 77. In other words, each of the springs 73, 74 preferably have a free length that is greater than the distance between the end of the corresponding spring stops 70, 72 and the corresponding travel stops 76, 77. In one aspect of the invention, the spring constants of the two springs 73, 74 can be adjusted to provide a different tactile feedback depending on the direction of movement of the grip platform 40. For instance, the spring 73 can be stiffer than the spring 74 so that forward movement (as designated by the arrow F in FIG. 4) counters greater resistance than movement in the opposite direction. If the forward movement of the controller slide member 58 corresponds to actuation of the accelerator pedal A, then the increased tactile resistance will allow for more controlled acceleration of the vehicle. On the other hand, having a less stiff spring 74 countering movement in the opposite or backward direction minimizes the resistance to movement of the joystick controller 22 when braking is desired. This can be especially important where a hard or emergency braking is necessary, in which case the tactile feedback feature of the system 20 should not pose an impairment to a quick response in case of an emergency.

In an alternative embodiment, the spring stops 70, 71 can be threaded, and the corresponding ends of the spring channels 68, 69 also threaded to permit threaded adjustment of the spring stops. In this manner, the spring stops 70, 71 can be threaded deeper into the corresponding spring channels 68, 69, to increase the resistive force generated by the corresponding springs 73, 74. The provision of threaded spring stops 70, 71 allows for more precise adjustment of the spring force resistance to forward or backward movement of the controller slide member 58, so that the joystick controller and control box 24 can be tailored to a particular driver's preference.

As shown in FIG. 7 the slide block 46 supports the turn signal switches 48. In a preferred embodiment, the slide block 46 defines switch bores 98 into which each turn signal switch 48 is disposed. Preferably the switches are push-button type switches that are activated by pressure on the spindle of the switch. The switches can be on-off type, meaning that the switches must be depressed to turn the signal on and off. Alternatively, the switches can require continued pressure and are deactivated when the switch is released.

As also indicated above, the slide block 46 supports the rocker 44. As can be seen in FIGS. 7, 9, and 10, the rocker 44 includes sidewalls 82 that flank the sides of the slide block 46 exposed above the control box 24. The side walls 82 are provided only on two sides of the rocker 44 so that the rocker 44 can be rocked or pivoted only along a plane parallel to the side wall 82, as indicated by the double arrows R shown in FIG. 7. These side walls 82 provide means for preventing the rocker and platform 40 from tilting in the fore-aft direction of movement of the joystick assembly 22.

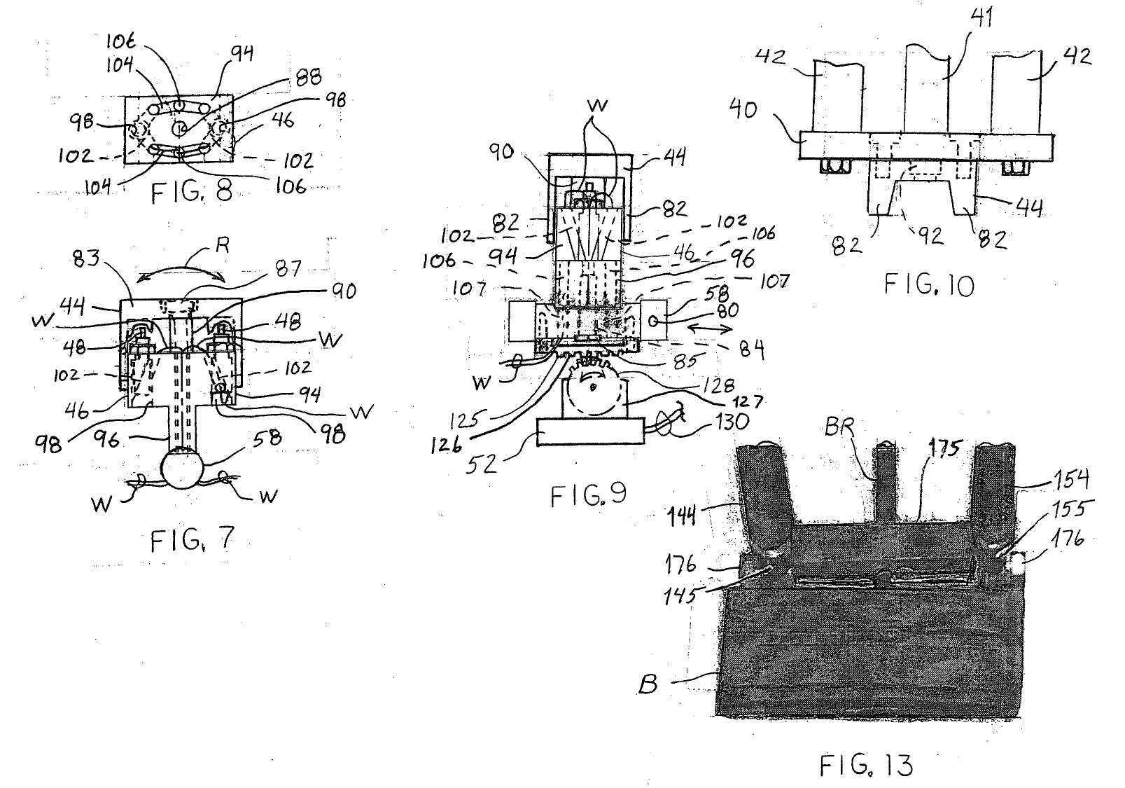

The rocker 44 also defines a body 83 that is integral with the side walls 82. The body defines a bolt recess 92 that allows the rocker 44 to be bolted to the slide block 46. In a preferred embodiment, the rocker and slide block are also bolted to the controller slide member 58, as shown in FIG. 9, to form a fully integrated construction. Thus, the controller slide member 58 can be provided with a T-nut bore 84 (FIGS. 4 and 9). A T-nut 85 can extend upward into the bore 84 to integrate with a bolt 87 that is fed through the bolt recess 92 of the rocker 44 and through a corresponding bore 88 (see FIG. 8) defined in the slide block 46. The bolt then engages the T-nut 85 internally within the bore 84 or the bore 88, depending on the length of the T-nut 85.

Since the rocker 44 must be permitted to rock from side to side as depicted by the direction arrow R in FIG. 7, the rocker cannot be solidly fixed to the slide block 46. Thus, a rocker support 90 can be provided that offsets the rocker 44 from the slide block 46, as shown in FIGS. 7 and 9. Preferably, the rocker support 90 is in the form of a flexible tubular body, such as a thick rubber washer. In addition, it is contemplated that the bolt recess 92 be sufficiently larger than the head of the rocker bolt 87 so that the rocker 44 has freedom of movement even when the bolt is engaged to the T-nut 85. In a further aspect of the preferred embodiment, a curved washer (not shown) can be disposed between the base of the bolt recess 92 and the head of the rocker bolt 87 so that the rocker is free to pivot even while the bolt remains fixed in position.

The control system 20, and particularly the control box 24 of the present invention, contemplates unique features associated with the slide block 46. In particular, the slide block 46 includes a body 94 from which extends a slide extension 96. The slide extension is configured to fit through the housing slot 62 (FIG. 4) in the controller housing 54 of the control box 24. Thus, the slide extension 96 has a width that is less than the width of the housing slot 62. It is of course understood that the housing block 62 intersects the slide channel 60 so that the slide extension 96 can mate with the controller slide member 58. Moreover, it is understood that the length of the slide extension 96 (i.e. its dimension along the long axis of the housing slot 62) is significantly less than the length of the slot 62 itself, in order to permit the expected degree of movement of the controller slide member 58 within the control box 24. Thus, as shown seen in FIG. 9, the length of the slide extension 96 is less than the length of the controller slide member 58. Preferably, the controller slide member 58 defines a recess to interlock with the free end of the slide extension 96 when the entire assembly is bolted together by way of the T-nut 85 and rocker bolt 87 as described above.

As shown in FIG. 8, the slide block body 94 defines switch bores 98 at the lateral sides of the body. The switch bores 98 support the turn signal switches 48, which necessarily include associated wiring. In order to accommodate the wiring and to prevent the wiring from interfering with the sliding movement of the controller slide member 58, the slide block body 94 is provided with a unique arrangement of wiring bores. In particular, the body 94 defines a pair of angled wiring bores 102 associated with each of the switch bores 98. The angled bores 102 intersect the corresponding switch bores 98 near the open end of the bores but inboard of the block body 94. In this way a wire, such as a wire W shown at the right side of the slide block 46 in FIG. 7 can accept the turn signal switch 48 and pass upward through an angled wiring bore 102 without being exposed outside the slide block body 94. The wires are threaded upward through the angled bores 102 and can pass along wiring channels 104 (FIG. 8) defined in the upper surface of the slide block body 94. The wires can then be threaded downward through a pair of feed bores 106 situated at the fore and aft sides of the slide block body 94. These feed bores 106 communicate with corresponding feed bores 107 defined in the controller slide member 58 as shown in FIG. 9. Thus, the wires W can be fully contained within the slide block body free and clear of the controller slide member 58 as shown in FIGS. 7 and 9. These wires can then be fed to the controller circuitry 52 mounted within the cover 50 (see FIGS. 5 and 9).

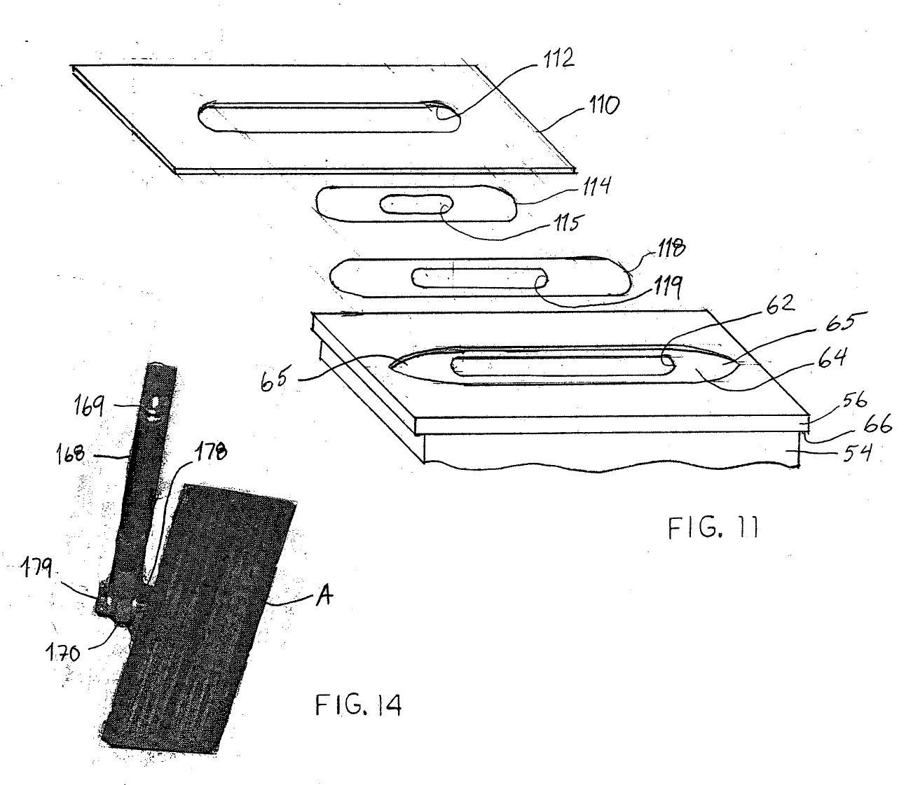

As depicted in FIG. 3, the control box 24 includes a top cover 110 that fits over the top plate 56 of the controller housing 54. Details of the top cover are shown in FIG. 11. A first feature is integrated into the top plate 56 of the controller housing 54. As indicated above, a slot 62 is defined in top plate 56 for sliding movement of the slide block 46. The top plate 56 also defines a recess 64 surrounding the slot 62. The opposite ends of the recess form tapered ends 65 that taper inwardly toward the longitudinal axis. In addition, the tapered ends 65 slope gradually upward toward the opening of the housing recess 64. The purpose for the tapered portions 65 will be explained in more detail below.

The top cover 110 is configured to sit generally coextensively with the top plate 56. The top cover 110 defines a slot 112 that has a length and width substantially equal to the length and width of the slot 62. It is of course understood that the slide block 46 also extends through the slot 112 and reciprocates within that slot as well as within the slot 62. Sandwiched between the top cover 110 and the top plate 56 are a pair of slot covers 114 and 118. The smaller slot cover 114 defines a slot 115 that has a length and width slightly larger than the length of the slide block 46. The larger slot cover 118 also defines a slot 119 that is larger in dimension than the slot 115 in the smaller slot cover 114, but is smaller than the slots 62 and 112.

The two slot covers 114 and 118 cooperate with each other to, in effect, provide a seal between the inside of the control box 24 and the environment outside the box. Thus, the two slot covers 114, 118 are free to slide back and forth within the housing recess 64 and are free to slide relative to each other. The largest slot cover 118 substantially covers the housing slot 62 in the controller housing 54. The smaller slot cover 114 covers a substantial portion of the slot 119 in the larger slot cover 118. Thus, the two slot covers 114, 118 provided overlapping coverage to minimize the chance of dust and dirt passing through the slot 62 and infecting the inner workings of the control box 24.

The tapered ends 65 of the housing recess 64 act as a sort of particle ejector. In other words, when dirt and dust does manage to pass through the top cover 110 and into the recess 64, movement of the larger slot cover 118 along the tapered ends 65 of the recess 64 has a tendency to push or eject dirt and dust particles from the recess. In this way, the combination of the slot covers 114, 118 with the tapered 65 help achieve a self-cleaning action for the control box 24.

Referring back to FIG. 9, it can be seen that in one embodiment of the invention a rack gear 125 is mounted to the underside of the controller slide member 58. The rack gear 125 moves forward and backward with the controller slide member 58 which movement is controlled by the vehicle driver by way of the joystick controller 22 and grip platform 40. The rack gear 125 interfaces with the control circuitry 52 to produce a signal indicative of the direction and magnitude of movement of the controller slide member 58, or ultimately the joystick controller 22.

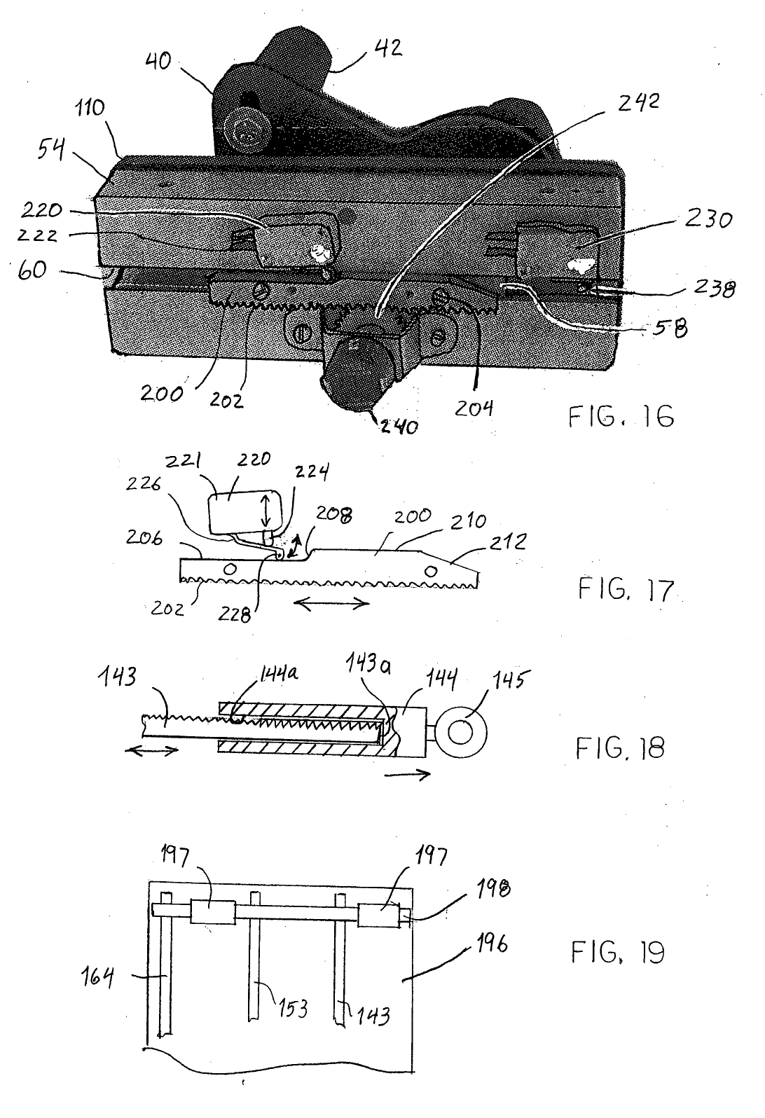

In one embodiment, the rack 125 includes teeth 126 that mesh with a sensor gear 128 of a movement sensor 127 that is supported by the controller circuitry 52, as shown in FIG. 9. The teeth 126 and the interface with the sensor gear 128 in this embodiment are vertical, or aligned with the slot 60 in the controller housing 54. In an alternative embodiment, shown in FIG. 16, a rack gear 200 is connected to the underside of the controller slide member 58 by a pair of fasteners 204. The rack gear 200 includes laterally oriented teeth 202 that mesh with a gear 242 of a movement sensor 240 that is supported on the underside of the controller housing 54. The interface between the rack gear 200 and the sensor gear 242 is essentially lateral relative to the controller housing 54.

With either embodiment, i.e., the rack gear 125 or 200, the direction and angular magnitude of rotation of the sensor gear 128 is translated by appropriate circuitry within the controller circuitry 52 into control signals. The control signals pass through control signal wires 130 to the actuator mechanism 30 to control the actuators as described wherein. It is understood that other forms of position and/or movement detectors or transducers may be used to translate the longitudinal movement of the grip platform 41 to signals indicative of a braking or an acceleration command from the vehicle operator.

More particularly, the controller circuitry 52 can include electronics and/or software that translate the clockwise or counter-clockwise rotation of the sensor gear 128 into an acceleration or a braking signal. In a specific embodiment, clockwise rotation of the sensor gear 128 corresponding to forward movement of the controller slide member 58 corresponds to an operator acceleration command. Conversely, counter-clockwise rotation of the sensor gear 128 can correspond to a braking command. Movement of the controller slide member 58 to either its forward or backward limits will cause the sensor gear 128 to move to it fullest clock wise or counter-clockwise angular extent. The circuitry and/or software within the control circuitry 52 can translate that movement into an appropriate command to fully depress the accelerator pedal A or the brake pedal B. With respect to the full stroke backward movements of the controller slide member 58 (and of course the joystick controller 22), can be calibrated to define an emergency braking condition.

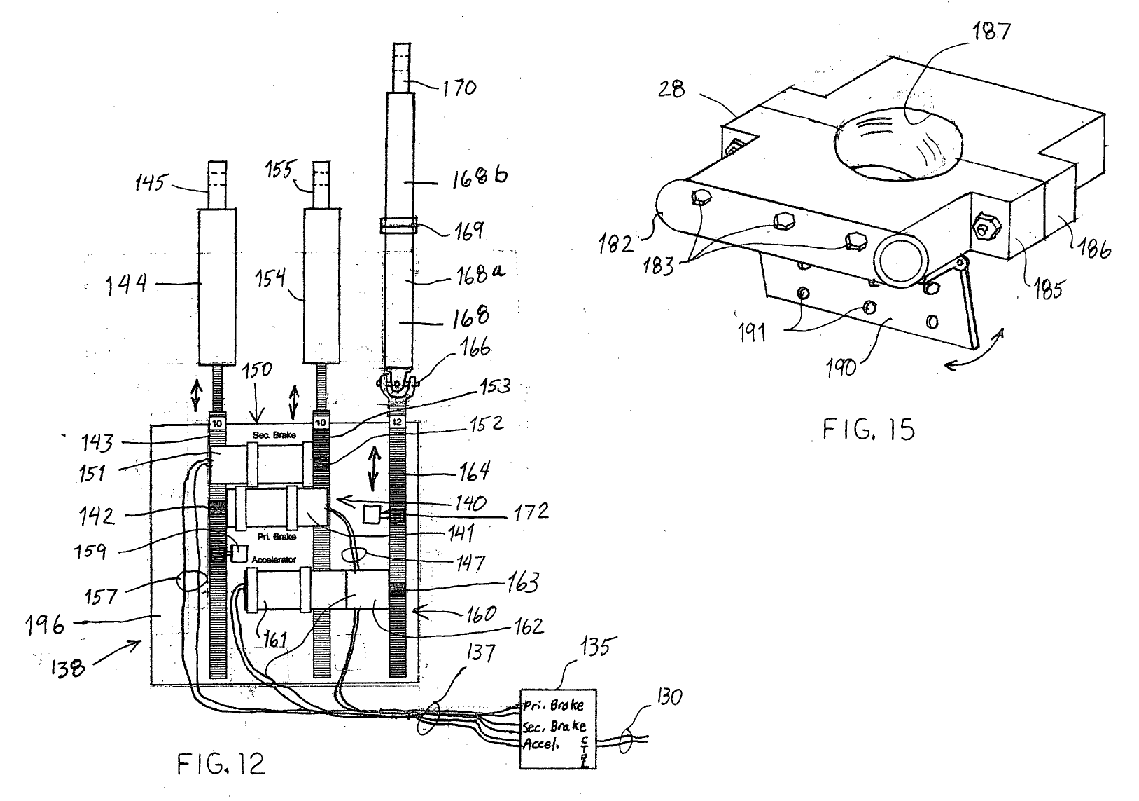

Thus, the controller circuitry 52 generates the control signals along the signal wires 130 that are fed to the actuator mechanism 30. In a preferred embodiment, the control wires 130 can pass through the hollow interior of the support arm 26. The control wires provide the acceleration/braking control signals to motor control circuitry 135 disposed within the actuator mechanism 30. As depicted in FIG. 2, the actuator mechanism 30 includes an actuator housing 192 that is configured to contain the motor control circuitry 135, as well as the motor assemblies depicted in FIG. 12. Preferably, the portion of the actuator housing 192 facing the driver includes padding 194 to prevent injury if it is accidentally contacted by the vehicle operator.

Turning to FIG. 12 the details of the actuator mechanism 30 can be seen. In the preferred embodiment, the brake pedal B and accelerator pedal A are controlled by way of electric motors. Thus, the motor control circuitry 135, which is preferably a microprocessor, transmits various control signals through motor control wires 137 fed to the actuator system 138. In the preferred embodiment, the brake pedal B is controlled by a primary brake assembly 140 and a secondary brake assembly 150. The two assemblies provide a fail-safe redundancy in the event of failure of one of the two brake assemblies. Each assembly 140, 150 includes a corresponding brake or motor 141, 151, drive spindle 142, 152 and rack gear 143, 153. Each rack gear is connected to a drive link 144, 154, each of which terminates in a drive tab 145, 155. Preferably, each drive tab 145, 155 is in the form of an eyebolt, as depicted in FIG. 18.

In addition, as shown in FIG. 18, each rack gear, such as the illustrated rack gear 143, is telescopically situated within a cavity 144a of the drive link 144. With this configuration as the rack gear 143 moves right, corresponding to an actuation of the primary brake motor 141, the rack gear slides within the cavity until the end 143a of the rack gear contacts the base of the cavity 144a. At this point, the rack gear pushes the drive link 144 to ultimately depress the brake pedal B. On the other hand, when the rack gear 143 is retracted toward the left in FIG. 18, the link slides freely within the cavity 144a and does not exert any restorative force on the drive link 144 or the brake pedal. Nominally, the brake pedal is self-restorative, meaning that it will naturally return to its neutral position. Optionally, a separate spring may be attached at one end to the brake pedal and at an opposite end to the actuator system 138 to assist restoring the brake pedal to its neutral non-braking position after the rack gear 143 has been retracted. One primary benefit of the telescoping interface between the rack gear 143 and the drive link 144 is that a different vehicle operator will be able to depress the brake pedal by normal foot operation. When the brake pedal B is depressed, the drive link 144 is drawn downward, while the rack gear 143 remains relatively stationary.

The drive link 144, 154 interface with the brake pedal B through the brake pedal arm BR as shown in FIG. 14. More specifically, a linking bracket 175 is fixed to the brake pedal arm BR. Attachment bolts 176 mate with the drive tabs 145, 155 to fix the drive links 144, 154 to the linking bracket 175. Preferably, the drive pins 145, 155 permit some degree of pivoting of the drive links 144, 154 relative to the linking bracket 175. However, the drive link 144, 154 must be solidly connected to the linking bracket 175 along the longitudinal axis of the links so that translation of the links directly and instantly cause a corresponding downward movement of the brake pedal B by operation of the force on the brake pedal arm BR. It should be readily apparent that immediate and accurate movement of the brake pedal B is essential to the safety of the vehicle driver. Thus, the redundant primary and secondary brake assemblies 140, 150 help ensure that the failure of any single brake assembly will not compromise the braking function of the vehicle.

In addition, the present invention contemplates a unique manner for supporting the actuator mechanism 30 to insure that the driving force generated by the primary and secondary brake assemblies is always perpendicular to the brake pedal arm BR, even as the arm BR is itself pivoted as the brake pedal B is depressed. This beneficial feature is accomplished through the mount 28 that is utilized to mount both the support arm 26 and the actuator mechanism 30. More specifically, the mount 28 is adapted to engage the vehicle steering column underneath the dashboard D as shown in FIG. 2. Referring to FIG. 15, the details of the steering column mount 28 can be seen. In particular, the mount 28 includes a support arm mount 182 that is preferably in the form of a hollow cylinder. A number of bolts 183 can pass through the cylindrical mount 182 and engage corresponding bolt holes (not shown) in the support arm 26 disposed within the mount 182.

The steering column mount 28 is preferably formed as a pair of clamp halves 185, 186. The two halves are configured to define a steering column opening 187 when the halves are bolted together. With this steering column mount 28 configured as shown in FIG. 15, only minor modification is required to the vehicle dashboard D, as shown in FIG. 2. In particular, the side of the dashboard directly beneath the steering column can be cut out to provide access to fix the clamp halves 185, 186 about the steering column.

In prior remote braking systems, the brake actuator includes a roller that contacts the brake pedal so the roller translates along the width of the pedal as it is depressed. With this prior approach, the line of action of the actuator force changes, thereby decreasing the mechanical advantage for the actuator. Moreover, the roller is susceptible to slipping off the brake pedal if the roller travels too much. The present invention eliminates these problems by providing the steering column mount 28 with a hinge 190 that is fixed to the underside of the mount, and preferably to the underside of the clamp half 185. The hinge plate 190 can include a number of screw holes 191 that allow the hinge plate to be fastened to the actuator housing 192 (FIG. 2). The hinge plate 190 thus permits pivoting of the actuator housing 192 relative to the fixed steering column mount 28. As the drive links 144, 154 are extended to depress the brake pedal B, the angular position of the actuator housing 192 is adjusted to account for the pivoting movement of the brake pedal arm BR, thereby maintaining a perpendicular force on the brake pedal arm BR by the extension of the primary and secondary brake assembly drive links.

In an alternative embodiment, the hinge plate 190 of FIG. 15 is replaced by a spindle configuration, as shown in FIG. 19. In this embodiment, a spindle 198 is rotatably supported within two collars 197 that are mounted to the mounting plate 196 of the actuator system 138. The cylindrical mount 182 can be interleaved between the two collars 197 with the spindle 198 extending through the mount. The spindle 198 thus retains the pivoting feature of the embodiment shown in FIG. 15.

Returning to FIG. 12, the actuator system 138 also includes an accelerator actuator assembly 160. The actuator assembly includes a drive motor 161 that rotates a drive spindle 163, preferably through a transmission, such as planetary gearing, to step down the motor speed to an appropriate speed for the rest of the accelerator actuator system 138. Preferably, the actuator assembly includes a clutch 162 between the motor/transmission and the spindle. In a preferred embodiment, the clutch is an electromagnetic clutch that is activated by a signal from the control circuitry 135 through one of the control wires 137. The clutch 162 can be a free-wheeling clutch when no electrical current is provided to the clutch. When power is applied to the drive motor 161 and clutch 162, the clutch engages so that rotation of the motor leads to direct rotation of the drive spindle 163.

As with the primary and secondary brake assemblies, the accelerator assembly includes a rack gear 164 that is a meshed engagement with the drive spindle 163. The rack gear 164 terminates in a U-joint 166 that mounts to the drive link 168. Thus, the U-joint 166 permits multiple degrees of freedom of movement to account for actuation of the accelerator assembly. In addition, this U-joint allows the accelerator pedal actuator to accommodate the pivoting of the actuator housing 192 that occurs when the brake pedal is depressed, as described above. With this configuration, the independence between the brake actuators and the accelerator actuator can be maintained while the overall size of the actuator system 138 can be kept to a minimum.

Preferably, the link 168 includes a link adjustment feature 169 that permits fine adjustment of the length of the accelerator drive link 168 upon installation, namely by adjusting the relative position of the link halves 168a, 168b. The drive end of the link 168 forms a clevis 170 that can engage the accelerator pedal A linkage by way of a link bracket at 178 and bolt 179, as shown in FIG. 14. The clevis end 170 of the link accommodates pivoting of the link relative to the link bracket 178 as the drive link 168 is extended to depress the accelerator pedal A. Where the drive links 144, 154 for the brake actuators are configured as shown in FIG. 18, the drive link 168 of the accelerator actuator can be similarly configured to allow telescoping movement between the U-joint 166 and the clevis end 170, or more specifically between the link halves 168a, 168b.

In the preferred embodiment, the free-wheeling clutch 162 essentially disconnects the drive link 168 from the motor 161 when power is shut off to the motor and clutch. In other words, when the joystick controller 22 (and ultimately the controller slide member 58) are not moved forward, but are instead at the neutral position as depicted in FIG. 4, or moved backward in a braking operation, then the accelerator drive link 168 is free to translate back and forth. With this arrangement, the return spring of the accelerator pedal is all that is necessary to push the drive link 168 back toward the actuator mechanism 30, restoring the rack gear 164 to its neutral position.

On the other hand, the primary and secondary brake assemblies do not permit a free-wheeling movement. In other words, the brake motors 141, 151 do not incorporate a clutch between the motor and the drive spindle 142. When power is terminated to either of the motors, the motors are held in whatever position they hold at the time power is terminated, which means that the rack gear 143, 153 are also held in their particular position. Ultimately, if the drive motors are fixed in position, then the drive links 144. 154 are fixed in position, which means that if the brake pedal B was depressed when the power to the brake assembly motors is terminated, then the brake will be maintained depressed. This is an important failsafe feature that permits release of the brake should electrical power to the actuator system 138 be interrupted for any reason.

The brakes are released, and more particularly, the primary and secondary brake motors 141, 151 are reversed, when the joystick controller 22 is moved to its neutral position, or forward of the neutral position. When the joystick is returned to its neutral position after a braking maneuver has been completed, this return movement is sensed by the control circuitry 52 which sends a signal to the motor control circuitry 135 to reverse the direction of the brake motors 141, 151. The motors are then reversed and the drive racks 143, 153 are retracted to release the brake pedal B. In one embodiment of the invention, proximity sensors or limit switches can be used to sense when the drive racks are at the limits of their stroke. In other words, when the brake motors 141, 151 are driven in reverse, a limit switch can be tripped by movement of the drive racks 143, 153 to prompt the motor control circuitry 135 to issue a motor stop command. Likewise, limit switches positioned at the limit of forward movement of the drive racks, corresponding to completely depressing the brake pedal B, can send a signal to the motor control circuitry to issue a motor stop command.

In addition to or in lieu of limit switches, the barking and steering rack gears can be monitored by position encoders. In one embodiment, a position encoder 159 can mesh with the rack gear 143 for the primary brake assembly 140. Likewise, a position encoder 172 can mesh with the rack gear 164 for the accelerator assembly 160. The position encoders can provide signals to the microprocessor 135 indicative of the stroke of the corresponding rack gear. When the rack gear reaches the limit of its extension or retraction travel, the microprocessor can issue an appropriate stop or return command to the corresponding motor 151 or 161.

In a more preferred embodiment of the invention, a limit switch can be used to sense a return of the brake motors to the neutral (non-braking) position, but an open-loop control system is used to determine when to stop the brake motors during a braking maneuver. In prior systems, a closed loop control system provides a positive limit to movement of the braking controls. These closed loop systems cannot account for mechanical variations in the operation of the vehicle brakes. For instance, over time, the brake pads wear, which means that the brake pedal B must be depressed farther. A closed loop system cannot account for this variation. On the other hand, the open loop control of the present invention accounts for this variation by, in essence, sensing the increase in resistance that occurs when the brake pedal is at or near its fully depressed position.

Thus, in one embodiment of the invention, the motor control circuitry 135 uses feedback on the current delivered to the motors 141, 151 to determine when to stop the motors at the end of a braking stroke. When the brake assembly 140 is actuated to depress the brake pedal B near its mechanical limit, the braking system exerts greater resistance to continued movement of the pedal, and consequently of the drive links 144, 154 of the brake assembly. As the motor torque increases to meet this increased load, the motor current increases. The motor control circuitry can sense this increase in current, either as a function of time or magnitude, to determine that the brake pedal is fully depressed. The motor control circuitry 135 then issues a motor stop command because the brake pedal has reached the mechanical limit of its stroke.

In another aspect of the motor control circuitry 135, the motor current is constantly monitored to determine if a problem exists in the braking or acceleration motors. If the current delivered to any motor is too low, an open circuit may exist. If the current delivered to the motor is too high, a short may exist in the motor. In either case, the function of the actuator mechanism 30 is compromised. The motor control circuitry 135, or microprocessor, can transmit a warning signal or illuminate an enunciator light to call attention to the condition.

In one feature of the invention, the drive components of the actuator system 138 are mounted on a common support plate 196 that forms part of the actuator housing 192. Thus, the primary and secondary brake motors 141, 151 and the accelerator motor 161 are mounted on this support plate. Moreover, the rack gears 143, 153 and 164 are slidably supported on the plate 196. This common support characteristic reduces the size of the envelop occupied by the actuator system 138 and minimizes the incursion into the driver's space behind the steering wheel S.

In specific embodiments of the invention, the motors in the actuator system 138 are precision DC motors. The accelerator motor 161 can be a 90 watt, 15V motor, with a no load speed of 7070 rpm and a maximum continuous torque of 77.7 mNm. Preferably, the accelerator motor is geared down at a ratio of 74:1 to rotate the drive spindle 163. In the specific embodiments, the primary brake motor 141 can be a 150 watt, 12V motor with a no load speed of 6920 rpm and a maximum continuous torque of 98.7 mNm. The primary brake motor can be geared down at a ratio of 156:1 to rotate the spindle 142. The secondary brake motor 151 can be similar to the primary motor.

In an alternative embodiment, the secondary brake motor can be a 150 watt, 48V motor with a no load speed of 7850 rpm and a maximum torque of 201 mNm. This alternative motor is geared down at a ratio of 43:1. In this embodiment, the secondary brake motor 151 operates as an emergency braking motor that is activated when the joystick is “pegged”. In other words, in an emergency braking condition, the joystick is pulled back as far and as quickly as possible. The control circuitry 52 can be configured to sense this rapid movement and issue an appropriate signal to the motor control circuitry.

However, in a preferred embodiment, a limit switch is positioned relative to the rack gear 125 so that when the rack gear is moved to its farthest extent by the joystick, the limit switch is actuated. When this limit switch is actuated, a signal is sent to the motor control circuitry to activate the secondary brake motor 151, which then quickly depresses the brake pedal for an emergency braking maneuver. In this alternative embodiment, the secondary brake motor is not normally activated, with the primary brake motor 141 absorbing the braking function of the system.

In one embodiment of the invention shown in FIG. 16, a pair of limit switches 220, 230 can be provided at the opposite ends of the stroke for the controller slide 58 and the rack gear 200 carried by the slide. The rack gear is configured for specific interaction with the two limit switches to provide an emergency braking function and to disconnect the accelerator motor clutch 162 when no acceleration command has been issued. Specifically, referring to FIG. 17 details of the rack gear 200 and one of the limit switches 220 can be seen. The limit switch 220 can include a spring biased pushbutton 224 that moves into and out of the switch housing 221 in the direction of the aligned arrows. The switch includes a spring arm 226 that bears against the pushbutton 224. The free end of the spring arm 226 includes a follower element 228 that can be in the form of a roller or a rounded contour to the arm. The follower element engages the rack gear 200 and governs the movement of the spring arm, and ultimately whether the arm depresses the pushbutton.

As shown in FIG. 17, the rack gear 220 includes a neutral edge 206 corresponding to a no acceleration condition, or a braking condition. When the follower element 228 contacts the neutral edge, the arm 226 is in its neutral position in which it does not depress the pushbutton 224. When the rack gear 200 moves to the right, which corresponds to an operator input braking command through the joystick 22, the follower element continues along the neutral edge and the pushbutton remains in its non-activated position. On the other hand, when the rack gear 200 is moved to the left, indicative of an acceleration command form the vehicle operator, the follower element rides up the sloped edge 208 to an activation edge 210. As the follower rides up the sloped edge 208, the follower element pushes the spring arm 226 toward the switch body 221 so that the spring arm depresses the pushbutton 224.

The switch 220 includes an electrical connector 222 that can mate with a wiring harness forming part of the control signal wires 130 (FIG. 12). When the switch 220 is deactivated (i.e., when the follower element is in contact with the neutral edge 206), a null signal is supplied to the motor control circuitry or microprocessor 135 directing the microprocessor to de-energize the clutch 162 for the accelerator assembly 160. Thus, the accelerator motor 161 is isolated from the vehicle accelerator pedal A and the pedal cannot be depressed. On the other hand, when the switch 220 is activated (i.e., when the follower element engages the activation edge 210), the closed switch directs the microprocessor to engage the clutch, thereby coupling the motor 161 to the accelerator pedal.

At the other end of the spectrum, a second limit switch 230 can be constructed like the switch 220 just described. This second switch includes a follower element 238 that contacts the rack gear 200 when the gear is at the farthest right extent of its stroke. This position of the rack gear 200 corresponds to an emergency braking command when the vehicle operator has pushed the grip platform 40 of the joystick fully forward. Referring again to FIG. 17, the rack gear 200 includes a forward sloped edge 212 that slopes rearward to the activation edge 210. When the rack gear is moved fully forward, the forward sloped edge 212 contacts the follower element 238 to depress the pushbutton and thereby activate the limit switch 230. In the preferred embodiment, this limit switch 230 is connected to controls for an emergency braking system. This emergency braking system is preferably independent of the motor control circuitry 135 and independent of the primary and secondary braking motors 141, 151. In one specific embodiment, the emergency braking system can constitute a four-wheel electric braking system that applies controlled barking to all wheels when the limit switch 230 is activated. With this specific embodiment, the emergency braking system bypasses the brake pedal B in favor of direct actuation of the vehicle brakes.

In the preferred embodiment of the invention, the electrical system of the control system 10 is connected to the vehicle electrical system. Preferably, this electrical connection is accomplished from the motor control circuitry 135, in the actuator mechanism 30 mounted to the steering column, to the vehicle fuse box. The electrical components within the control box 24 for the joystick 22 can be supplied with power from the motor control circuitry, rather than independently from the vehicle electrical system. In one embodiment, the actuator mechanism 30 can include a back-up power supply, such as a battery, mounted within the actuator housing 192. This battery back-up can thus supply electricity to the control circuitry to permit activation of the brake assemblies 140, 150 even after a loss of vehicle power.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

1. A system for use by a physically impaired driver for controlling the brake pedal and accelerator pedal of a vehicle, comprising:
a manually manipulated hand controller, movable in a first direction to control the brake pedal and in a second direction to control the accelerator pedal;
an actuator assembly including;
a first actuator operably coupled to the brake pedal to depress the brake pedal when activated; and
a second actuator operably coupled to the accelerator pedal to depress the accelerator pedal when activated;
an electrical control system connected between said hand controller and said actuator assembly and operable to activate said first actuator when said hand controller is moved in said first direction and to activate said second actuator when said hand controller is moved in said second direction; and
a housing supporting said actuator assembly, said housing pivotably mounted to the vehicle above the brake pedal so that said actuator assembly pivots relative to the vehicle when said first actuator is activated to depress the brake pedal.

2. The system for use by a physically impaired driver for controlling the brake pedal and accelerator pedal of a vehicle of claim 1, further comprising a support arm connecting said hand controller to said housing.

3. The system for use by a physically impaired driver for controlling the brake pedal and accelerator pedal of a vehicle of claim 1, wherein said housing includes:
a mounting clamp configured to engage the steering column of the vehicle; and
a hinge connecting said housing to said mounting clamp.

4. The system for use by a physically impaired driver for controlling the brake pedal and accelerator pedal of a vehicle of claim 3, further comprising a support arm connecting said hand controller to said mounting clamp.

5. The system for use by a physically impaired driver for controlling the brake pedal and accelerator pedal of a vehicle of claim 1, wherein said housing includes exterior padding.

6. A system for use by a physically impaired driver for controlling the brake pedal and accelerator pedal of a vehicle, comprising:
a manually manipulated hand controller, movable in a first direction to control the brake pedal and in a second direction to control the accelerator pedal;
an actuator assembly including;
a brake actuator system operably coupled to the brake pedal to depress the brake pedal when activated, said brake actuator system including;
a primary electric motor;
a secondary electric motor, operable independent of said primary electric motor; and
a linkage assembly commonly coupling said primary and secondary electric motors to the brake pedal; and
an accelerator actuator system operably coupled to the accelerator pedal to depress the accelerator pedal when activated; and
an electrical control system connected between said hand controller and said actuator assembly and operable to activate said brake actuator system when said hand controller is moved in said first direction and to activate said accelerator actuator system when said hand controller is moved in said second direction.

7. The system for use by a physically impaired driver for controlling the brake pedal and accelerator pedal of a vehicle of claim 6, wherein said linkage assembly includes:
a link bracket mounted to the brake pedal; and
for each of said primary and secondary electric motors:
a drive spindle connected to each said motor;
a rack gear mechanically coupled to said drive spindle; and
a drive link connected between said rack gear and said link bracket.

8. The system for use by a physically impaired driver for controlling the brake pedal and accelerator pedal of a vehicle of claim 6, wherein:
said accelerator actuator system includes a electric accelerator motor; and
said actuator assembly includes a support plate commonly supporting said accelerator motor and said primary and secondary motors.

9. The system for use by a physically impaired driver for controlling the brake pedal and accelerator pedal of a vehicle of claim 9, wherein said support plate is pivotably mounted to the vehicle above the brake pedal so that said support plate pivots relative to the vehicle when said brake actuator system is activated to depress the brake pedal.

10. The system for use by a physically impaired driver for controlling the brake pedal and accelerator pedal of a vehicle of claim 9, wherein said accelerator actuator system includes:
an accelerator drive spindle connected to said accelerator motor;
an accelerator rack gear mechanically coupled to said accelerator drive spindle;
an accelerator drive link connected between said accelerator rack gear and the accelerator pedal; and
a U-joint connected to said accelerator drive link between said accelerator rack gear and the accelerator pedal.

11. A system for use by a physically impaired driver for controlling the brake pedal and/or accelerator pedal of a vehicle, comprising:
an actuator assembly operably coupled to at least one pedal of the brake pedal and the accelerator pedal, said actuator assembly operable in response to control signals to depress said at least one pedal;
a manually manipulated hand controller including;
a body defining a slide channel;
a slide member disposed within said slide channel for sliding movement in a fore-aft direction;
means responsive to the position of said slide member within said slide channel for generating said control signals; and
a joystick assembly mounted to said slide member and manually manipulable to slide said slide member within said slide channel, said joystick assembly including a platform, a gripping post at a forward end of said platform and a pair of offset support posts at a rearward end of said platform arranged to receive the forearm of the driver resting on said platform when the driver is gripping said gripping post.

12. The system for use by a physically impaired driver for controlling the brake pedal and accelerator pedal of a vehicle of claim 11, wherein:
said gripping platform is mounted to said slide member to permit tilting of said platform in a direction substantially transverse to said fore-aft direction; and
said hand controller includes a pair of transversely offset switches arranged underneath said gripping platform so that tilting of said platform actuates a corresponding one of said pair of switches, each of said switches electrically connected to operate a corresponding component of the vehicle.

13. The system for use by a physically impaired driver for controlling the brake pedal and accelerator pedal of a vehicle of claim 12, wherein said gripping platform includes means for preventing tilting of said platform in said fore-aft direction.

14. A system for use by a physically impaired driver for controlling the brake pedal and/or accelerator pedal of a vehicle, comprising:
an actuator assembly operably coupled to at least one pedal of the brake pedal and the accelerator pedal, said actuator assembly operable in response to control signals to depress said at least one pedal;
a manually manipulated hand controller including;
a body defining a slide channel;
a slide member disposed within said slide channel for sliding movement in a fore-aft direction;
means responsive to the position of said slide member within said slide channel for generating said control signals;
a manually grippable joystick assembly mounted to said slide member and manually manipulable to slide said slide member within said slide channel, said joystick assembly including a platform for supporting the forearm of the driver when operating the joystick assembly, said platform supported relative to said slide member to permit tilting of said platform in a direction substantially transverse to said fore-aft direction; and
a pair of transversely offset switches arranged underneath said platform so that tilting of said platform actuates a corresponding one of said pair of switches, each of said switches electrically connected to operate a corresponding component of the vehicle.

15. The system for use by a physically impaired driver for controlling the brake pedal and/or accelerator pedal of claim 14, wherein:
said pair of switches includes a plurality of electrical wires for electrical connection to the corresponding component of the vehicle; and
said slide member defines at least one wiring channel for receiving said plurality of electrical wires therethrough so that said plurality of wires pass through said slide channel in said body of said hand controller without interfering with the sliding movement of said slide member within said slide channel.

16. A system for use by a physically impaired driver for controlling the brake pedal and/or accelerator pedal of a vehicle, comprising:
an actuator assembly operably coupled to at least one pedal of the brake pedal and the accelerator pedal, said actuator assembly operable in response to control signals to depress said at least one pedal;
a manually manipulated hand controller including;
a body defining a channel and an upward facing slot in communication with said channel;
a slide member disposed within said channel for sliding movement in a fore-aft direction;
means responsive to the position of said slide member within said channel for generating said control signals;
a joystick assembly mounted to said slide member and manually manipulable to slide said slide member in said fore-aft direction within said channel;
a slide block connecting said joystick assembly to said slide member, said slide block having a length less than the length of said slide member in said fore-aft direction;
a top plate disposed over said upward facing slot, said top plate defining a housing slot in communication with said upward facing slot and a recess surrounding said housing slot;
a larger slot cover disposed within said recess and having a length less than a length of said recess, said larger slot cover defining a first slot in communication with said housing slot, said first slot having a length greater than the length of said slide block but less than the length of said housing slot; and
a smaller slot cover disposed within said recess between said larger slot cover and said slide block, said smaller slot cover having a length less than the length of said larger slot cover but greater than the length of said first slot, and said smaller slot cover further defining a second slot having a length slightly greater than the length of said slide block and greater than the length of said first slot, but less than the length of said larger slot cover.

17. A system for use by a physically impaired driver for controlling the brake pedal and/or accelerator pedal of a vehicle, comprising:
an actuator assembly operably coupled to at least one pedal of the brake pedal and the accelerator pedal, said actuator assembly operable in response to control signals to depress said at least one pedal;
a manually manipulated hand controller including;
a body defining a slide channel;
a slide member disposed within said slide channel for sliding movement in a fore-aft direction;
means responsive to the position of said slide member within said slide channel for generating said control signals;
a manually grippable joystick assembly mounted to said slide member and manually manipulable to slide said slide member within said slide channel; and
a centering mechanism connected between said slide member and said body to center said slide member within said slide channel, said centering mechanism including two opposing springs, each operably connected to an opposite end of said slide member so that one of said springs is compressed when the other of said springs is extended.

18. The system for use by a physically impaired driver for controlling the brake pedal and/or accelerator pedal of a vehicle of claim 17, wherein said two opposing springs are coil springs aligned in said fore-aft direction.

19. The system for use by a physically impaired driver for controlling the brake pedal and/or accelerator pedal of a vehicle of claim 17, wherein said opposing springs have different spring constants.
